(19) United States
(12) Patent Application Publication
(10) Pub. No.: US 2006/0064836 A1
(43) Pub. Date: Mar. 30, 2006

(54) Paint roller cleaner

(76) Inventor: William B. Mowe, Lawrenceville, GA (US)

Correspondence Address: Harry I. Leon, 924 Bowen St. NW, Atlanta, GA, 30318, US

(21) Appl. No.: 11/259,725

(22) Filed: Oct. 26, 2005

Related U.S. Application Data
(63) Continuation-in-part of application No. 29/213,926, filed on Sep. 24, 2004, now Pat. No. D511600.

(51) Int. Cl. B05C 21/00

(52) U.S. Cl. 15/236.03

(57) ABSTRACT

A tool for pushing excess paint or other liquid sources off of a paint roller sleeve without having to remove the sleeve. The tool comprises a handgrip, an elongated rod and a generally circular loop formed as a single, unitary piece of a straight section of rod. Disposed away from the handgrip, the loop, is slip fitted over the sleeve of the roller. Excess paint can be removed by inserting the sleeve in the circular section of the tool. This can be done while holding the paint roller in one hand and the cleaning tool in the other hand and then the tool is slipped over the sleeve The tool can either be slipped over the open end of the roller or over the frame of the roller or the of the roller can be inserted through a narrow gap defined by the loop and with a forward and aft motion, the excess paint is then squeezed from the sleeve and with forward and aft motion the excess paint is squeezed from the sleeve.

### CROSS REFERENCE TO RELATED APPLICATION

The subject matter of this application was disclosed in U.S. Design patent application Ser. No. 29/213,926 having a filing date of Sep. 24, 2004.

### SUMMARY OF THE INVENTION

The object of this invention is to provide a tool for the removal of excess paint from a paint roller while the roller is still installed on its handle. A further object is to provide such a tool can be used to remove excess paint without the user having to manually contact the paint roller.

The tool is comprises an elongated rod, a handgrip on one end thereof, a generally circular loop which extends from the rod at points thereon distal from the hand grip.

The rod and the loop are defined by a single, unitary structure; and the loop has an inner diameter of a size which allows it to be slip fitted over the sleeve of a standard paint roller. Moreover, the loop is not completely closed, leaving a gap which is slightly larger that the diameter of the paint roller frame.

To clean or remove excess paint from the paint roller sleeve, one slips the loop over the paint roller, passing a portion of the paint roller frame disposed proximate with the roller through the gap in the loop. The user can then to hold the tool in one hand and the paint roller handle in the other and squeeze excess paint off of the sleeve.

In the preferred embodiment, the elongated rod, which together with the handgrip forms the handle of the tool, is disposed at an angle of approximately 70 degrees above the horizontal plane when the circular loop is held generally horizontally, thereby providing for an increase of approximately 6 inches in the distance at which the loop is held from the user's body over the separation which would otherwise be realized if the handle were disposed perpendicularly to the loop. As a result, user is less likely to be splattered with paint during the process.

### BRIEF DESCRIPTION OF THE DRAWINGS

FIG. 1 is a front elevational view of the paint roller cleaner according to the present invention, the paint roller itself, paint dripping therefrom and the paint can being shown in dashed lines for illustrative purposes only and forming no part of the claimed invention;

FIG. 2 is a closeup perspective view of the paint roller cleaner according to FIG. 1 showing how it can be slipped on the paint roller sleeve without requiring removal of the sleeve from the handle, the paint roller being shown for illustrative purposes only and forming no part of the claimed invention;

FIG. 3 is a front elevational view of the paint roller cleaner according to FIG. 1;

FIGS. 4 and 5 are right side and left side elevational views, respectively, of the paint roller cleaner according to FIG. 1; and

FIGS. 6 and 7 are top and bottom plan views, respectively, of the paint roller cleaner according to FIG. 1.

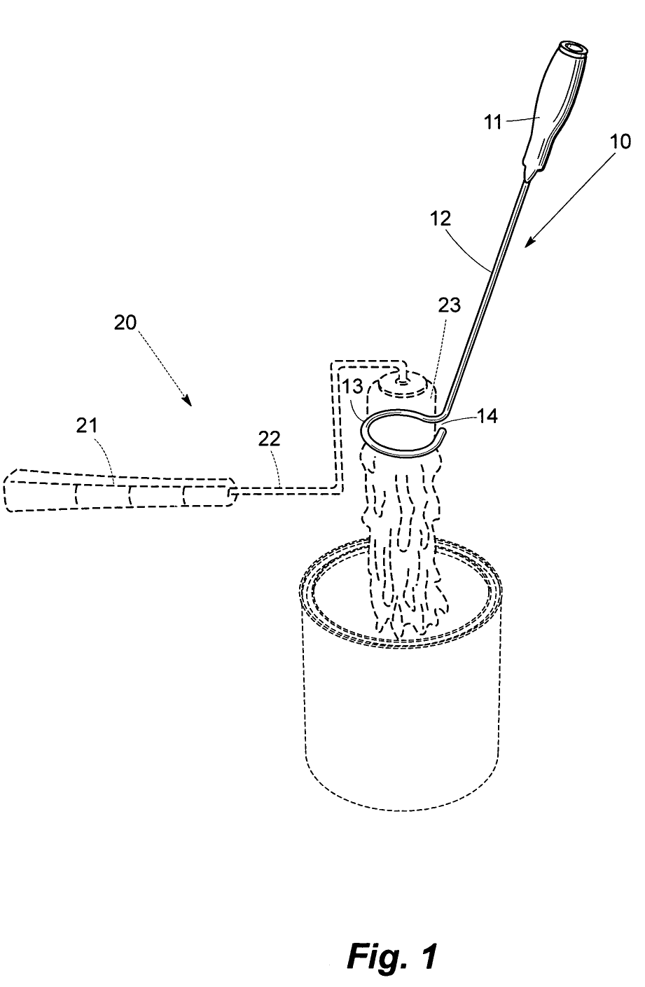

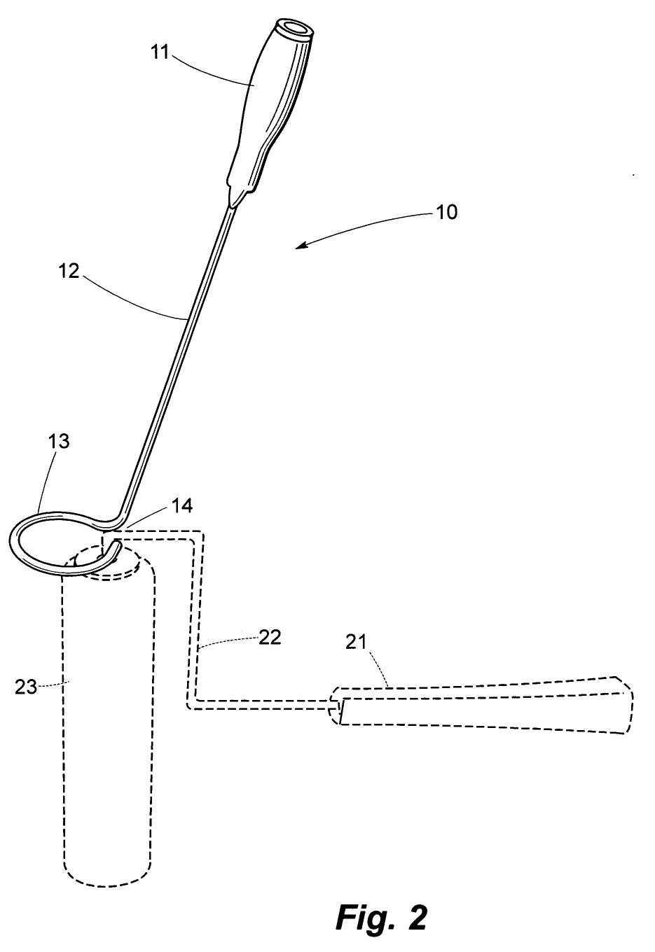

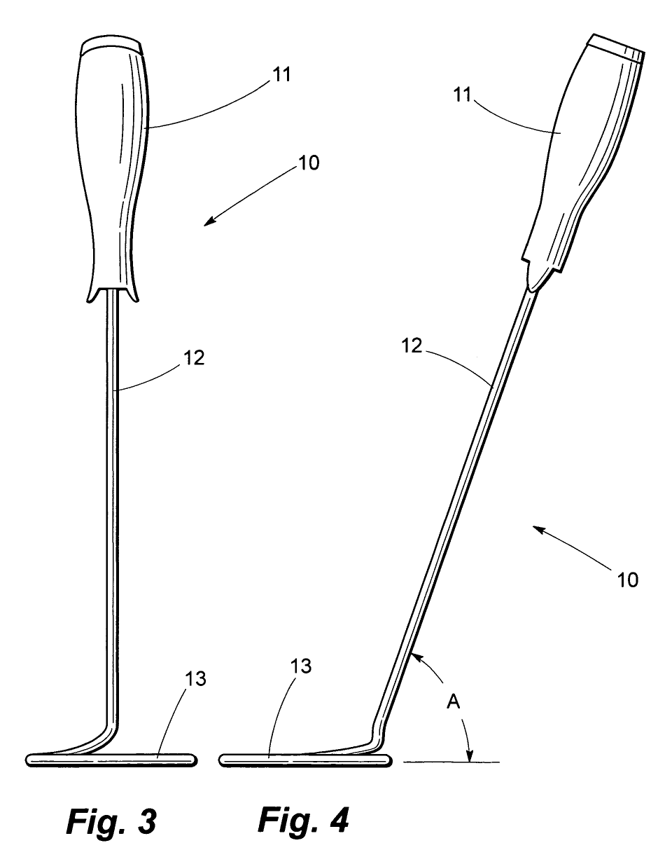

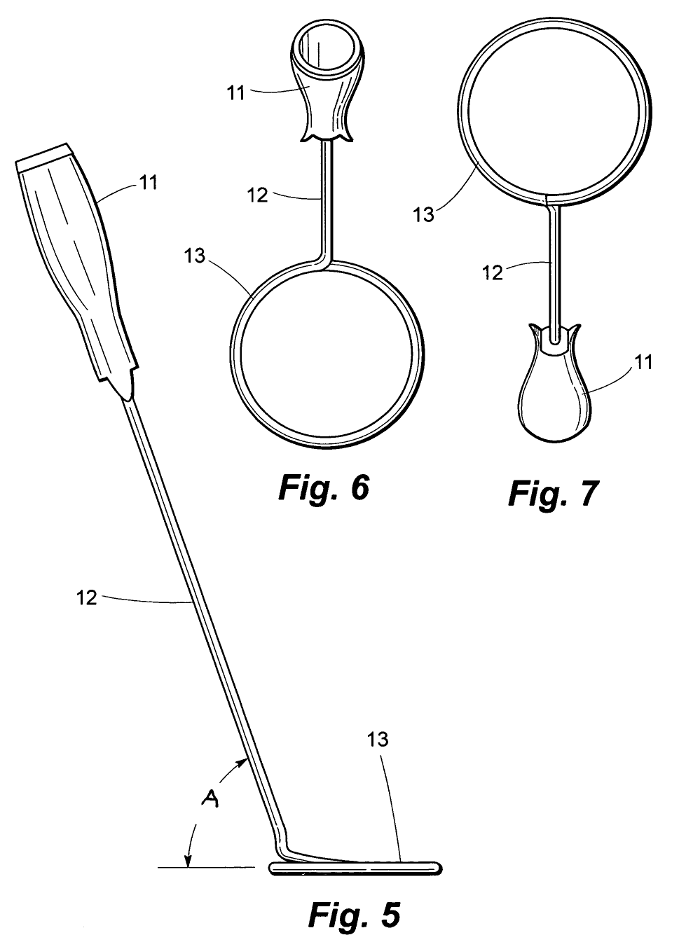

### DETAILED DESCRIPTION OF THE PREFERRED EMBODIMENT

In the drawings, an improved paint roller cleaner indicated generally by the reference numeral 10. This tool is comprises a handgrip 11 and an elongated rod 12 that extends downwardly from the handgrip. Distal from the handgrip 11, the rod 12 terminates in a generally circular loop which is not completely closed but rather defines a gap 14. The inner diameter of the loop 13 is slightly larger than the outer diameter of the paint roller sleeve 23 when the surface of the sleeve is compressed by the loop 13. The gap 14 in the loop 13 is a sized large enough to slip over the frame 22 of the paint roller 20.

To make the tool 10 easier to use the handgrip 11 and the rod 12 are disposed at an angle “A” to the imaginary plane in which most of the loop 13 lies at any given moment. In the preferred embodiment this angle is about 70 degrees

The user holds the paint roller 20 by its handle 21 in one hand and the paint roller cleaner handgrip 11 in the other hand. Then then he inserts the paint roller frame 22 through the gap 14 and allows the loop 13 to slip over the sleeve 23. Then with an easy forward and aft motion, he moves the tool 10 over the sleeve 23 to remove the excess paint.

It is claimed

1. A tool for cleaning of paint roller sleeves, while the sleeve is mounted on a paint roller frame, comprising:
(a) a handgrip;
(b) an elongated rod extending downwardly from the handgrip; and
(c) a generally circular loop formed at the end of the rod distal from the hand grip, the loop and the rod being defined by a single, unitary structure, the loop having an inner diameter which is slightly larger than the outer diameter of each sleeve compressed outer surface.

2. A tool according to claim 1, wherein the loop defines a small gap that is slightly larger than the transverse cross-section of a portion of the paint roller frame disposed proximate with the sleeve.

3. The tool according to claim 1, wherein the elongated rod is disposed at an angle of about 70 degrees above the horizontal plane when the loop is held generally horizontally.
